(19) United States
(12) Patent Application Publication
(10) Pub. No.: US 2024/0145764 A1
(43) Pub. Date: May 2, 2024

(54) MULTILAYER SOLID STATE ELECTROLYTE FOR ENERGY STORAGE DEVICES

(71) Applicant: HYZON MOTORS USA INC., Honeoye Falls, NY (US)

(72) Inventors: Rajesh Bashyam, Delta (CA); Sai Nitin Yellamilli, Naperville, IL (US)

(21) Appl. No.: 18/495,293

(22) Filed: Oct. 26, 2023

Related U.S. Application Data
(60) Provisional application No. 63/419,515, filed on Oct. 26, 2022.

(51) Int. Cl. H01M 10/056; H01M 10/0525

(52) U.S. Cl. CPC H01M 10/056; H01M 10/0525; H01M 2220/20; H01M 2300/0077; H01M 2300/0082; H01M 2300/0091; H01M 2300/0094

(57) ABSTRACT

Ways of making a solid-state electrolyte are provided. Various energy storage devices, such as solid-state lithium-ion batteries, may incorporate the solid-state electrolyte. The solid-state electrolyte may be manufactured by dissolving a fluoropolymer with a solvent, combining a portion of the dissolved fluoropolymer with an ionic liquid to form a PVDF-HFP/IL-Li salt solution, and combining a portion of the dissolved fluoropolymer with lithium lanthanum zirconium oxide to form a PVDF-HFP/LLZO solution. Then, coating a first side of a porous membrane with the VDF-HFP/IL-Li salt solution and coating a second side of the porous membrane with PVDF-HFP/LLZO solution to thereby form the solid-state electrolyte.

### CROSS-REFERENCE TO RELATED APPLICATIONS

This application claims the benefit of U.S. Provisional Application No. 63/419,515, filed on Oct. 26, 2022. The entire disclosure of the above application is incorporated herein by reference.

### FIELD

The present technology includes processes and articles of manufacture that relate to solid-state electrolytes for energy storage devices, including solid-state electrolytes for lithium-ion batteries.

### INTRODUCTION

This section provides background information related to the present disclosure which is not necessarily prior art.

Rechargeable lithium-ion batteries provide certain advantages, as lithium is the lightest and most electropositive element, which are properties that are important for high energy density. Advantages of lithium-ion batteries include a long shelf life, long cycle life, and the ability to store more energy than lead-acid, nickel-cadmium, and nickel metal hydride batteries.

Certain lithium-ion batteries use organic liquid electrolytes, which may be based on alkyl carbonates. Organic liquid electrolytes may provide a wide electrochemical window, good ionic conductivity, and chemical stability. However, organic liquid electrolytes may also be volatile, flammable, and certain liquid electrolytes may produce toxic compounds (e.g., hydrofluoric acid) when exposed to water. Lithium-ion batteries having such electrolytes may therefore present issues when employed in certain conditions.

Certain lithium-ion batteries further employ separators formed from polypropylene (PP) and polyethylene (PE), which have limited thermal stability. Such separators may experience melting and/or deformation at certain temperatures, including temperatures below 170° C. Deformation of the separator may cause direct contact between positive and negative electrodes within the battery, resulting in an internal short circuit of a battery cell and an exothermic chemical reaction.

Certain lithium-ion batteries may also exhibit dendritic growth of lithium metal onto graphite negative electrodes, which may have the potential to produce an internal short circuit. In particular, lithium dendrites may extend and may accumulate over time, pierce a separator within the battery, and cause a short circuit that may result in undesired thermal events, including battery failure. Ways to minimize lithium dendrite formation and/or growth are therefore of interest in the manufacture of lithium-ion batteries.

All solid-state batteries (ASSB) are gaining significant attention in lithium-ion battery development due to several advantages, including consistent operation, high energy density, and faster charging properties. However, certain challenges remain to be overcome, especially with respect to solid-state electrolytes (SSE), in order to improve ionic conductivity and suppress formation of lithium dendrites and manufacturing solid electrolytes at high volume. Two main approaches are being employed in development of solid electrolytes, the first being the use inorganic ceramic solid electrolytes and the second being use of a solid polymer electrolyte, where both approaches have their own advantages and disadvantages.

Accordingly, there is a need for low cost, reinforced solid polymer electrolytes that are mechanically, electrochemically, and thermally stable in a lithium polymer electrolyte for integration into various energy storage devices, such as solid-state lithium-ion batteries.

### SUMMARY

In concordance with the instant disclosure, the present technology includes articles of manufacture, systems, and processes that relate to solid polymer electrolytes that optimize mechanical, electrochemical, and thermal performance in lithium polymer electrolyte systems, and which may be integrated into energy storage devices including lithium-ion polymer batteries.

Ways of making and using a solid-state electrolyte are provided. Various energy storage devices, such as solid-state lithium-ion batteries, may incorporate the solid-state electrolyte. The solid-state electrolyte may be manufactured by dissolving a fluoropolymer with a solvent, combining a portion of the dissolved fluoropolymer with an ionic liquid to form a PVDF-HFP/IL-Li salt solution, and combining a portion of the dissolved fluoropolymer with lithium lanthanum zirconium oxide to form a PVDF-HFP/LLZO solution. Then, coating a first side of a porous membrane with the VDF-HFP/IL-Li salt solution and coating a second side of the porous membrane with PVDF-HFP/LLZO solution to thereby form the solid-state electrolyte.

In certain embodiments, a method of making a solid-state electrolyte may include combining a first fluoropolymer dissolved in a first solvent, an ionic liquid, and a lithium salt to form a fluoropolymer-ionic liquid-lithium salt solution. A second fluoropolymer may be dissolved in a second solvent and a lithium lanthanum zirconium oxide (LLZO) to form a fluoropolymer-LLZO solution. A first side of a porous substrate may be coated with the fluoropolymer-ionic liquid-lithium salt solution to form a fluoropolymer-ionic liquid-lithium salt coating and a second side of the porous substrate may be coated with the fluoropolymer-LLZO solution to form a fluoropolymer-LLZO composite.

In certain embodiments, one of the first fluoropolymer and the second fluoropolymer may include poly(vinylidene fluoride-co-hexafluoropropylene) and the other of the first fluoropolymer and the second fluoropolymer may include poly(vinylidene fluoride-co-hexafluoropropylene). The poly(vinylidene fluoride-co-hexafluoropropylene) may include a polyvinylidene fluoride and hexafluoropropylene weight ratio selected from a group consisting of 90:10, 85:15, 82:18, and combinations thereof. In certain embodiments, one of the first solvent and the second solvent may include acetone and the other of the first solvent and the second solvent may include acetone. The first fluoropolymer may be dissolved in the first solvent at 50° C. The first fluoropolymer dissolved in the first solvent may be combined with the ionic liquid in a ratio of 1:2.

The fluoropolymer-LLZO solution may include 25 wt % of LLZO. The ionic liquid may include a member selected from a group consisting of 1-ethyl-3-methylimidazolium bis(trifluoromethylsulfonyl)imide, N-methyl N-propylpiperidium bis(trifluoromethylsulfonyl)imide, 1-ethyl-3-methylimidazolium bis(fluorosulfonyl)imide. N-methyl N-propylpiperidium bis(fluorosulfonyl)imide, 1-ethyl-3-methylimidazolium hexafluorophosphate, and N-methyl N-propylpiperidium hexafluorophosphate, and combinations thereof. In certain embodiments, the lithium salt may include a member selected from a group consisting of: LiPF₆; LiBF₄; LiBOB (lithium bisoxalato borate); LiTFSI (lithium bis(trifluorosulfonyl)imide); LiFSI (lithium fluorosulfonylimide); LiClO₄; LiAsF₆; LiSbF₆; LiSA; LiTf (lithium trifluoromethanesulfonate); LiCTFSI (lithium cyano(trifluoromethanesulfonyl)imide); LiTDI (lithium 4,5-dicyano-2-trifluoromethylimidazole); LiPDI (lithium 4,5-dicyano-2-(pentafluoroethyl) imidazolide); LiDCTA (lithium 4,5-dicyano-1,2,3-triazolate); and LiB(CN)₄, and combinations thereof.

In certain embodiments, the porous substrate may include a coating of ceramic particles. In certain embodiments, the method may further include disposing a first side of another porous substrate on the fluoropolymer-ionic liquid-lithium salt coating. A second side of the other porous substrate may be coated with another fluoropolymer-LLZO solution to form another fluoropolymer-LLZO composite. The porous substrate and the other porous substrate may be formed of the same material and the fluoropolymer-LLZO composite and the other fluoropolymer-LLZO composite may be formed of the same material. The method may include coating the fluoropolymer-ionic liquid-lithium salt coating with another fluoropolymer-LLZO solution to form another fluoropolymer-LLZO composite.

In certain embodiments, the fluoropolymer-LLZO composite and the other fluoropolymer-LLZO composite may be formed of the same material. In certain embodiment, the method may include a solid-state electrolyte. In still certain embodiments, the method may include a solid-state lithium-ion battery comprising a solid-state electrolyte made according to the method. A vehicle may include a solid-state lithium-ion battery including a solid-state electrolyte made according to the method.

In certain embodiments, a method of making a solid-state electrolyte may comprise combining a first fluoropolymer dissolved in a first solvent including acetone, an ionic liquid, and a lithium salt to form a fluoropolymer-ionic liquid-lithium salt solution. The first fluoropolymer dissolved in the first solvent may be combined with the ionic liquid in a ratio of 1:2. A second fluoropolymer may be dissolved in a second solvent and a lithium lanthanum zirconium oxide (LLZO) to form a fluoropolymer-LLZO solution including 25 wt % of LLZO. In certain embodiments, one of the first fluoropolymer and the second fluoropolymer may include poly(vinylidene fluoride-co-hexafluoropropylene) and the other of the first fluoropolymer and the second fluoropolymer includes poly(vinylidene fluoride-co-hexafluoropropylene). A first side of a porous substrate may be coated with the fluoropolymer-ionic liquid-lithium salt solution to form a fluoropolymer-ionic liquid-lithium salt coating. A second side of the porous substrate may be coated with the fluoropolymer-LLZO solution to form a fluoropolymer-LLZO composite.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a flowchart illustrating a method of making a solid-state electrolyte, according to an embodiment of the present disclosure.

FIG. 2 graphically depicts electrochemical stability windows by linear sweep voltammetry (LSV) results by measuring a Li metal/PVDF-HFP Li+ ionic liquid (IL) membrane/stainless steel coin cell embodiments of solid-state lithium-ion batteries; and

FIGS. 3A-3C include schematic depictions of multilayer solid-state electrolytes according to embodiments of the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of”. Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

The present technology relates to low cost, reinforced solid polymer electrolytes which provide mechanically, electrochemically, and thermally stable Li-polymer electrolyte systems, which may be integrated into energy storage devices including lithium-ion polymer batteries. Ways of making and using a solid-state electrolyte for use in an energy storage device may include dissolving a fluoropolymer, mixing the dissolved fluoropolymer with an ionic liquid, adding a lithium salt, and impregnating a porous substrate to thereby form the solid electrolyte.

Embodiments of methods of making solid-state electrolytes for use in lithium-ion batteries may include the following aspects. Poly(vinylidene fluoride-co-hexafluoropropylene) (PVDF-HFP) copolymer may be dissolved in acetone at 50° C. A portion of the dissolved PVDF-HFP may be mixed with ionic liquid (IL) in the ratio of 1:2. A lithium salt may be added to the PVDF-HFP/IL liquid solution. The solution may be stirred overnight. The resultant solution is a PVDF-HFP/IL-Li salt solution. Another portion of the dissolved PVDF-HFP may be mixed with 25 weight percent lithium lanthanum zirconium oxide (LLZO). The solution may be stirred overnight. The resultant solution may include a PVDF-HFP/LLZO solution.

Certain embodiments may include a reinforced solid-state electrolyte for a solid-state lithium-ion battery, where the reinforced solid-state electrolyte includes a porous reinforcement including porous substrate, ceramic particles, and a dispersion. The ceramic particles may form a coating on the porous substrate.

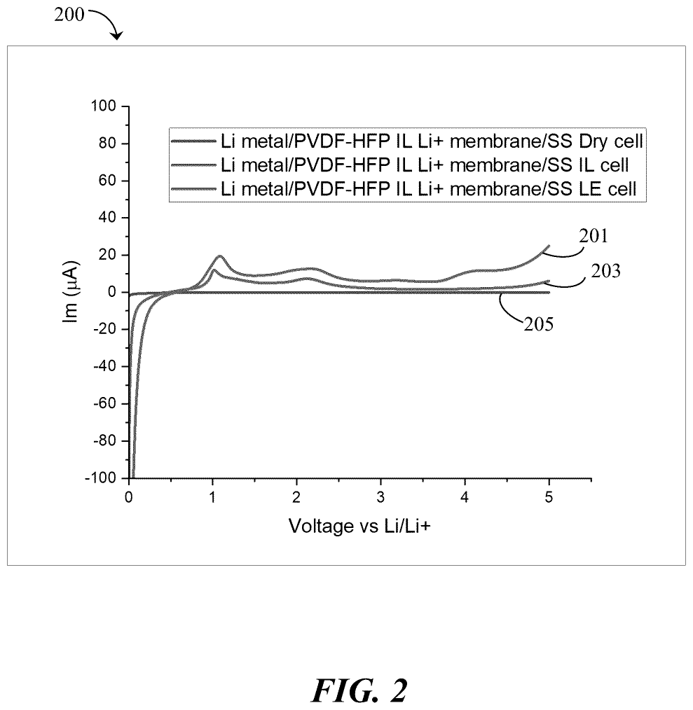

The PVDF-HFP/IL-Li salt solution may be used to coat a first side of the porous reinforcement and the PVDF-HFP/LLZO solution may be used to coat a second side of the porous reinforcement to thereby produce a mechanically strong solid-state electrolyte. In certain embodiments, as shown in FIG. 2, the solutions may be arranged in further configurations with layers of the porous substrate.

The PVDF-HFP copolymer may have various weight ratios of polyvinylidene fluoride (PVDF) to hexafluoropropylene (HFP), such as 90:10, 85:15, and 82:18.

The ionic liquid may include one or more of: 1-ethyl-3-methylimidazolium bis(trifluoromethylsulfonyl)imide, N-methyl N-propylpiperidium bis(trifluoromethylsulfonyl)imide, 1-ethyl-3-methylimidazolium bis(fluorosulfonyl)imide. N-methyl N-propylpiperidium bis(fluorosulfonyl)imide, 1-ethyl-3-methylimidazolium hexafluorophosphate, and N-methyl N-propylpiperidium hexafluorophosphate

Lithium salts may include one or more of: LiPF₆; LiBF₄; LiBOB (lithium bisoxalato borate); LiTFSI (lithium bis(trifluorosulfonyl)imide); LiFSI (lithium fluorosulfonylimide); LiClO₄; LiAsF₆; LiSbF₆; LiSA; LiTf (lithium trifluoromethanesulfonate); LiCTFSI (lithium cyano(trifluoromethanesulfonyl)imide); LiTDI (lithium 4,5-dicyano-2-trifluoromethylimidazole); LiPDI (lithium 4,5-dicyano-2-(pentafluoroethyl) imidazolide); LiDCTA (lithium 4,5-dicyano-1,2,3-triazolate); and LiB(CN)₄.

The following table identifies ionic conductivities of PVDF-HFP-IL membranes constructed in accordance with the present technology.

| Solid State Electrolyte (SSE) Sample | Ionic Conductivity (S/cm) |
|---|---|
| PVDF-HFP LLZO \|\| 20 wt % | 4.7 × 10⁻⁴ |
| LITFSI in PVDF-HFP and IL | |
| PVDF-HFP LLZO \|\| 60 wt % | 5 × 10⁻⁴ |
| LITFSI in PVDF-HFP and IL | |
| PVDF-HFP with LLZO | 5 × 10⁻⁶ |

As may be seen, the composite PFSA-Li membranes (e.g., PVDF-HFP/LLZO composites) may exhibit greater ionic conductivity than only a PFSA-Li membrane.

Solid electrolytes and solid-state energy storage devices including such electrolytes, may be manufactured according to the present technology to provide reinforced solid polymer electrolytes that are mechanically, electrochemically, and thermally stable in a lithium polymer electrolyte used in forming a lithium-ion battery. In particular, solid-state lithium-ion batteries incorporating the present solid electrolytes may provide improved performance.

Reinforced solid-state electrolytes may be manufactured at scale with higher conductivity and stability. Manufacture of the composite solid polymer electrolytes and/or reinforced solid polymer electrolytes may include using various layer-by-layer and/or roll-to-roll techniques, thereby allowing the use of high throughput production methods. In this way, various solid-state lithium-ion batteries may include or be manufactured using the composite and/or reinforced solid-state electrolytes provided by the present technology.

Various reinforced solid-state electrolytes may be made in accordance with the present technology. Such electrolytes may be used in manufacture of various solid-state lithium-ion batteries in accordance with the present technology. Various solid-state lithium-ion batteries made in accordance with the present technology may be used as power sources in various applications, including electric vehicles and electronic devices.

The present technology provides certain benefits and advantages in all lithium-ion solid state batteries, including batteries used for various portable and mobility applications such as vehicles. Several issues with respect to lithium-ion batteries are addressed by the present technology, including suppressing the formation of lithium metal dendrites and higher conductivity, where the present batteries may provide more consistent performance and cycling durability. All solid-state batteries as manufactured and provided herein may attain a higher capacity than other such batteries and are suitable for operation in expanded environments, including environments where batteries fabricated using volatile, flammable, liquid electrolytes would impose certain limitations or be undesirable.

Example embodiments of the present technology are provided with reference to the several figures enclosed herewith.

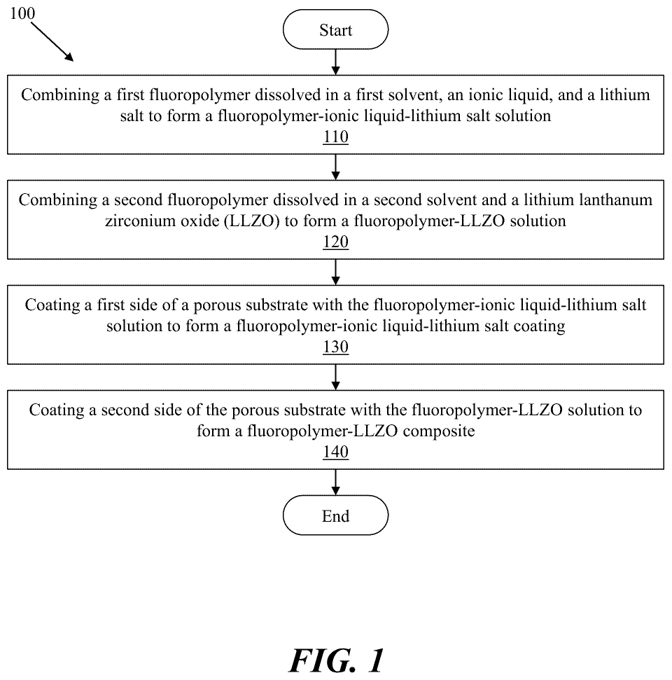

FIG. 1 is a flowchart 100 that describes a method of making a solid-state electrolyte, according to an embodiment of the present disclosure. In certain embodiments, at step 110, the method may include combining a first fluoropolymer dissolved in a first solvent, an ionic liquid, and a lithium salt to form a fluoropolymer-ionic liquid-lithium salt solution. At step 120, the method may include combining a second fluoropolymer dissolved in a second solvent and a LLZO to form a fluoropolymer-LLZO solution. Then, at step 130, the method may include coating a first side of a porous substrate with the fluoropolymer-ionic liquid-lithium salt solution to form a fluoropolymer-ionic liquid-lithium salt coating and at step 140, the method may include coating a second side of the porous substrate with the fluoropolymer-LLZO solution to form a fluoropolymer-LLZO composite.

In certain embodiments, one of the first fluoropolymer and the second fluoropolymer may include poly(vinylidene fluoride-co-hexafluoropropylene) and the other of the first fluoropolymer and the second fluoropolymer may include poly(vinylidene fluoride-co-hexafluoropropylene). The poly(vinylidene fluoride-co-hexafluoropropylene) may include a polyvinylidene fluoride and hexafluoropropylene weight ratio selected from a group consisting of 90:10, 85:15, 82:18, and combinations thereof. In certain embodiments, one of the first solvent and the second solvent may include acetone and the other of the first solvent and the second solvent may include acetone. The first fluoropolymer may be dissolved in the first solvent at 50° C. The first fluoropolymer dissolved in the first solvent may be combined with the ionic liquid in a ratio of 1:2.

The fluoropolymer-LLZO solution may include 25 wt % of LLZO. The ionic liquid may include a member selected from a group consisting of 1-ethyl-3-methylimidazolium bis(trifluoromethylsulfonyl)imide, N-methyl N-propylpiperidium bis(trifluoromethylsulfonyl)imide, 1-ethyl-3-methylimidazolium bis(fluorosulfonyl)imide. N-methyl N-propylpiperidium bis(fluorosulfonyl)imide, 1-ethyl-3-methylimidazolium hexafluorophosphate, and N-methyl N-propylpiperidium hexafluorophosphate, and combinations thereof. In certain embodiments, the lithium salt may include a member selected from a group consisting of: LiPF₆; LiBF₄; LiBOB (lithium bisoxalato borate); LiTFSI (lithium bis(trifluorosulfonyl)imide); LiFSI (lithium fluorosulfonylimide); LiClO₄; LiAsF₆; LiSbF₆; LiSA; LiTf (lithium trifluoromethanesulfonate); LiCTFSI (lithium cyano(trifluoromethanesulfonyl)imide); LiTDI (lithium 4,5-dicyano-2-trifluoromethylimidazole); LiPDI (lithium 4,5-dicyano-2-(pentafluoroethyl) imidazolide); LiDCTA (lithium 4,5-dicyano-1,2,3-triazolate); and LiB(CN)₄, and combinations thereof.

In certain embodiments, the porous substrate may include a coating of ceramic particles. In certain embodiments, the method may further include disposing a first side of another porous substrate on the fluoropolymer-ionic liquid-lithium salt coating. A second side of the other porous substrate may be coated with another fluoropolymer-LLZO solution to form another fluoropolymer-LLZO composite. The porous substrate and the other porous substrate may be formed of the same material and the fluoropolymer-LLZO composite and the other fluoropolymer-LLZO composite may be formed of the same material. The method may include coating the fluoropolymer-ionic liquid-lithium salt coating with another fluoropolymer-LLZO solution to form another fluoropolymer-LLZO composite.

In certain embodiments, the fluoropolymer-LLZO composite and the other fluoropolymer-LLZO composite may be formed of the same material. In certain embodiment, a solid-state electrolyte may be made according to the method. In certain embodiments, a solid-state lithium-ion battery comprising a solid-state electrolyte made according to the method. In still certain embodiments, a vehicle including a solid-state lithium-ion battery including a solid-state electrolyte may be made be made according to the method.

In certain embodiments, the method of making a solid-state electrolyte may comprise combining a first fluoropolymer dissolved in a first solvent including acetone, an ionic liquid, and a lithium salt to form a fluoropolymer-ionic liquid-lithium salt solution. The first fluoropolymer dissolved in the first solvent may be combined with the ionic liquid in a ratio of 1:2. A second fluoropolymer may be dissolved in a second solvent and a lithium lanthanum zirconium oxide (LLZO) to form a fluoropolymer-LLZO solution including 25 wt % of LLZO. In certain embodiments, one of the first fluoropolymer and the second fluoropolymer may include poly(vinylidene fluoride-co-hexafluoropropylene) and the other of the first fluoropolymer and the second fluoropolymer includes poly(vinylidene fluoride-co-hexafluoropropylene). A first side of a porous substrate may be coated with the fluoropolymer-ionic liquid-lithium salt solution to form a fluoropolymer-ionic liquid-lithium salt coating. A second side of the porous substrate may be coated with the fluoropolymer-LLZO solution to form a fluoropolymer-LLZO composite.

As shown in FIG. 2, the electrochemical stability windows 200 are graphically depicted by a linear sweep to show voltammetry (LSV) results by measuring Li metal/PVDF-HFP Li+IL membrane/stainless steel coin cell embodiments of a solid-state lithium-ion battery. FIG. 2 shows the Li metal/PVDF-HFP IL membrane/SS Dry cell 205, the Li metal/PVDF-HFP IL membrane/SS IL cell 201, and the Li metal/PVDF-HFP IL membrane/SS LE cell 203.

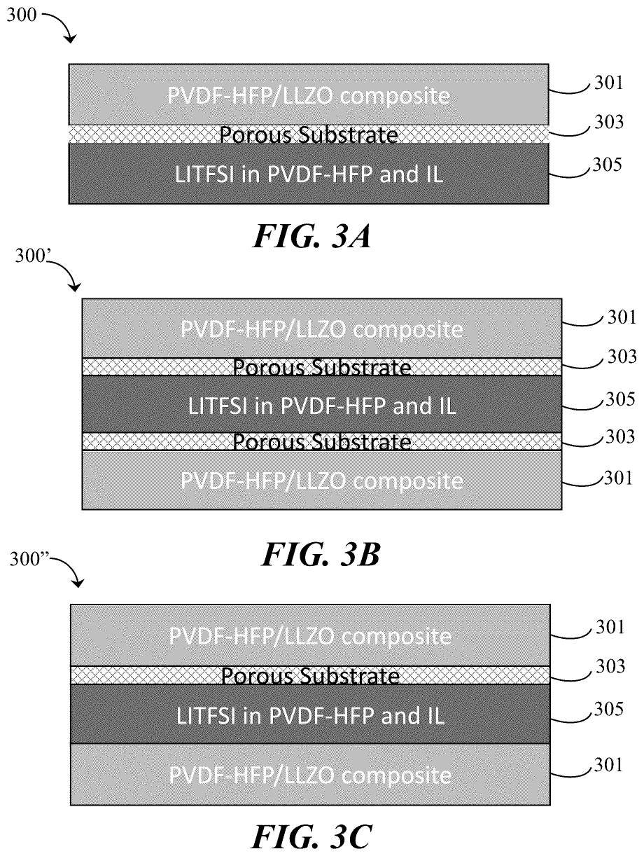

FIGS. 3A-3C depict the multilayer solid state electrolyte 300. As shown in FIG. 3A, a first fluoropolymer may be dissolved in a first solvent, an ionic liquid, and a lithium salt to form a fluoropolymer-ionic liquid-lithium salt solution and combined with a second fluoropolymer dissolved in a second solvent and a LLZO to form a fluoropolymer-LLZO solution 301. A first side of a porous substrate 303 may be coated with the fluoropolymer-ionic liquid-lithium salt solution to form a fluoropolymer-ionic liquid-lithium salt coating 305 and also coated on a second side of the porous substrate 303 with the fluoropolymer-LLZO solution to form a fluoropolymer-LLZO composite 301. As shown in FIG. 3B, a multilayer solid state electrolyte 300′ may further include disposing a first side of another porous substrate 303 on the fluoropolymer-ionic liquid-lithium salt coating 305 and coating a second side of the another porous substrate 303 with another fluoropolymer-LLZO solution to form another fluoropolymer-LLZO composite 301. Alternatively, as shown in FIG. 3C, a multilayer solid state electrolyte 300″ may include a coating of fluoropolymer-ionic liquid-lithium salt coating 305 with another fluoropolymer-LLZO solution to form another fluoropolymer-LLZO composite 301.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of making a solid-state electrolyte, comprising:
combining a first fluoropolymer dissolved in a first solvent, an ionic liquid, and a lithium salt to form a fluoropolymer-ionic liquid-lithium salt solution;
combining a second fluoropolymer dissolved in a second solvent and a lithium lanthanum zirconium oxide (LLZO) to form a fluoropolymer-LLZO solution;
coating a first side of a porous substrate with the fluoropolymer-ionic liquid-lithium salt solution to form a fluoropolymer-ionic liquid-lithium salt coating; and
coating a second side of the porous substrate with the fluoropolymer-LLZO solution to form a fluoropolymer-LLZO composite.

2. The method of claim 1, wherein one of the first fluoropolymer and the second fluoropolymer includes poly(vinylidene fluoride-co-hexafluoropropylene).

3. The method of claim 2, wherein the other of the first fluoropolymer and the second fluoropolymer includes poly(vinylidene fluoride-co-hexafluoropropylene).

4. The method of claim 1, wherein one of the first solvent and the second solvent includes acetone.

5. The method of claim 4, wherein the other of the first solvent and the second solvent includes acetone.

6. The method of claim 4, wherein the first fluoropolymer is dissolved in the first solvent at 50° C.

7. The method of claim 2, wherein the poly(vinylidene fluoride-co-hexafluoropropylene) includes a polyvinylidene fluoride and hexafluoropropylene weight ratio selected from a group consisting of 90:10, 85:15, 82:18, and combinations thereof.

8. The method of claim 1, wherein the first fluoropolymer dissolved in the first solvent is combined with the ionic liquid in a ratio of 1:2.

9. The method of claim 1, wherein the fluoropolymer-LLZO solution includes 25 wt % of LLZO.

10. The method of claim 1, wherein the ionic liquid includes a member selected from a group consisting of: 1-ethyl-3-methylimidazolium bis(trifluoromethylsulfonyl)imide, N-methyl N-propylpiperidium bis(trifluoromethylsulfonyl)imide, 1-ethyl-3-methylimidazolium bis(fluorosulfonyl)imide. N-methyl N-propylpiperidium bis(fluorosulfonyl)imide, 1-ethyl-3-methylimidazolium hexafluorophosphate, and N-methyl N-propylpiperidium hexafluorophosphate, and combinations thereof.

11. The method of claim 1, wherein the lithium salt includes a member selected from a group consisting of: LiPF₆; LiBF₄; LiBOB (lithium bisoxalato borate); LiTFSI (lithium bis(trifluorosulfonyl)imide); LiFSI (lithium fluorosulfonylimide); LiClO₄; LiAsF₆; LiSbF₆; LiSA; LiTf (lithium trifluoromethanesulfonate); LiCTFSI (lithium cyano(trifluoromethanesulfonyl)imide); LiTDI (lithium 4,5-dicyano-2-trifluoromethylimidazole); LiPDI (lithium 4,5-dicyano-2-(pentafluoroethyl) imidazolide); LiDCTA (lithium 4,5-dicyano-1,2,3-triazolate); and LiB(CN)₄, and combinations thereof.

12. The method of claim 1, wherein the porous substrate includes a coating of ceramic particles.

13. The method of claim 1, further comprising:
disposing a first side of another porous substrate on the fluoropolymer-ionic liquid-lithium salt coating; and
coating a second side of the another porous substrate with another fluoropolymer-LLZO solution to form another fluoropolymer-LLZO composite.

14. The method of claim 13, wherein the porous substrate and the other porous substrate are formed of the same material and the fluoropolymer-LLZO composite and the another fluoropolymer-LLZO composite are formed of the same material.

15. The method of claim 1, further comprising:
coating the fluoropolymer-ionic liquid-lithium salt coating with another fluoropolymer-LLZO solution to form another fluoropolymer-LLZO composite.

16. The method of claim 15, wherein the fluoropolymer-LLZO composite and the another fluoropolymer-LLZO composite are formed of the same material.

17. A method of making a solid-state electrolyte, comprising:
combining a first fluoropolymer dissolved in a first solvent including acetone, an ionic liquid, and a lithium salt to form a fluoropolymer-ionic liquid-lithium salt solution, wherein the first fluoropolymer dissolved in the first solvent is combined with the ionic liquid in a ratio of 1:2;
combining a second fluoropolymer dissolved in a second solvent and a lithium lanthanum zirconium oxide (LLZO) to form a fluoropolymer-LLZO solution including 25 wt % of LLZO,
wherein one of the first fluoropolymer and the second fluoropolymer includes poly(vinylidene fluoride-co-hexafluoropropylene) and the other of the first fluoropolymer and the second fluoropolymer includes poly(vinylidene fluoride-co-hexafluoropropylene);
coating a first side of a porous substrate with the fluoropolymer-ionic liquid-lithium salt solution to form a fluoropolymer-ionic liquid-lithium salt coating; and
coating a second side of the porous substrate with the fluoropolymer-LLZO solution to form a fluoropolymer-LLZO composite.

18. A solid-state electrolyte made according to the method of claim 1.

19. A solid-state lithium-ion battery comprising a solid-state electrolyte made according to the method of claim 1.

20. A vehicle comprising a solid-state lithium-ion battery including a solid-state electrolyte made according to the method of claim 1.
